(19) United States
(12) Patent Application Publication
(10) Pub. No.: US 2009/0307328 A1
(43) Pub. Date: Dec. 10, 2009

(54) REMOTE MANAGEMENT INTERFACE FOR A MEDICAL DEVICE

(75) Inventors: Luke Nuttall, Thebarton (AU); Nicholas Betts, Thebarton (AU)

Correspondence Address: Kevin McNamara, PO BOX 736, Torrensville, SA, 5031, omitted

(73) Assignee: SIGNOSTICS PTY LTD, Torrensville (AU)

(21) Appl. No.: 12/477,924

(22) Filed: Jun. 4, 2009

(30) Foreign Application Priority Data
Jun. 5, 2008 (AU) AU2008902837

(51) Int. Cl. G06F 15/16; G06F 3/02; G06F 15/167; G06F 15/177

(52) U.S. Cl. 709/212; 345/168; 709/217; 709/221

(57) ABSTRACT

A method and system for remote management of a hand held medical device of a type which does not include a physical keyboard or a large display screen including connectable hardware providing a communications channel between the device and a remote computer system to provide a fully featured interface, with a full sized screen and keyboard, for use when manipulating data from the medical device.

### TECHNICAL FIELD

The present invention relates to a method and apparatus for connection of a hand held medical device to a remote data management system, in particular a personal computer running a display and management application.

### BACKGROUND ART

Physicians have available to them an increasing number of separate portable electronic devices to use in the diagnosis of patients. These devices include stethoscopes, otoscopes, ophthalmoscopes, thermometers, and blood pressure detectors. Portable ultrasound devices have also been recently developed. Ultrasound scanning machines in particular, have progressively shrunk in size and increased in functionality.

There are advantages in cost and patient care in facilitating performance of diagnostic tasks using electronic device at the point of care. The ability of physicians to easily record data and images during their investigation is also of great use for reference and monitoring of certain conditions.

These devices are increasingly small and have an increasing ability to produce data, and to process that data to provide meaningful information.

Increasingly, it will be advantageous for the functions of these devices to be combined, at least for common functions such as processing and power supply

The progress of electronics and information technology has made the control of such machines a much more significant problem. The received signal may be digitised. This enables a wide range of complex digital signal processing techniques to be applied, which would have been prohibitively difficult to apply in analogue componentry. The user or manufacturer controls these functions by computer program control. The number and range of these controls accessible to a user is considerable. A quite rich and complex user interface is required to manage the range of options.

These machines also provide many convenient features beyond the mere receipt and display of diagnostic data and scan images. A full computer user interface is provided, enabling patient identification data to be added and associated with diagnostic data and scans. Scans can be stored for later retrieval, or transmitted over computer networks. Text and graphic annotations can be added to scans.

In order to implement the complex user interface, a keyboard and a computer style screen were provided.

The latest ultrasound devices are fully portable, comprising only a control unit which may be hand held and a probe unit which contains the ultrasound transmission and reception electronics. These do not have large screens or physical keyboards. They have user interfaces based on touchscreens and virtual keyboards. These devices may also have limited data storage.

This has greatly extended the usefulness of ultrasound, especially bringing it into the emergency ward and to assist in such routine procedures as line insertion.

The small size of the latest diagnostic devices has also brought the units into the point-of-care sphere, outside of hospital settings. Ultrasound in particular is no longer the exclusive preserve of radiologists and other such specialist practitioners. Ultrasound is proving useful in the hands of primary care physicians, emergency ward doctors and para-professionals such as nurses and paramedics.

Data management, including patient data, scan data and parameter data may be inconvenient on such small devices.

### DISCLOSURE OF THE INVENTION

In one form of this invention there is proposed a system for remote management of a hand held medical device including connectable hardware means adapted to provide a communications channel between the device and a remote computer system with software means adapted to identify at least the class of the device to the system and to provide access to a data store of the device there being provided means to transfer medical scan data from the data store of the device to the system and means to store, examine and annotate the scan data along with means to display the scan data and any associated patient information or annotations to a user of the system.

The system is thus able to provide a fully featured interface, with a full sized screen and keyboard, for use when manipulating data from the medical device. It is not necessary for these large peripheral devices to be present when the device is being used for data collection in a clinical setting.

The medical device may be a single function device, such as an ECG monitor or an ultrasound scanner. In general it will be a multi-functional device, able to collect a variety of medical diagnostic data using multiple or exchangeable diagnostic probes.

In preference, the data manipulation means is provided in the form of at least one software plug-in, with different plug-ins being able to be selected for use by the system, the selection being made based on the type of medical scan data transferred from the hand held device.

The system is able to identify the type of medical data collection probe or the type of medical data which has been collected and is able to present an interface appropriate for the manipulation of that data. The use of software plug-ins means that only those parts of the system and the interface which change depending upon the type of medical data to be manipulated need change between use with different data types or probe types. This has advantages in development time and in user training time.

In a further form, the invention may be said to lie in a method of remote management of a hand held medical device including providing a communications channel between the device and a remote computer system;

identifying at least the class of the device to the system;
providing access to a data store of the device;
transferring medical scan data from the data store of the device to the system;
manipulating the data to store, examine and annotate the scan data;
displaying the scan data and any associated patient information or annotations to a user of the system.

### BRIEF DESCRIPTION OF THE DRAWINGS

FIG. 1 is an illustration of a hand held device, as used with the current invention.

FIG. 2 illustrates the system of the invention set up for use.

FIG. 3 is a block diagram of the system of the invention.

FIG. 4 is an illustration of the main screen of the system of the invention.

FIG. 5 is an illustration of the device control screen of the system of the invention.

### BEST MODE FOR CARRYING OUT THE INVENTION

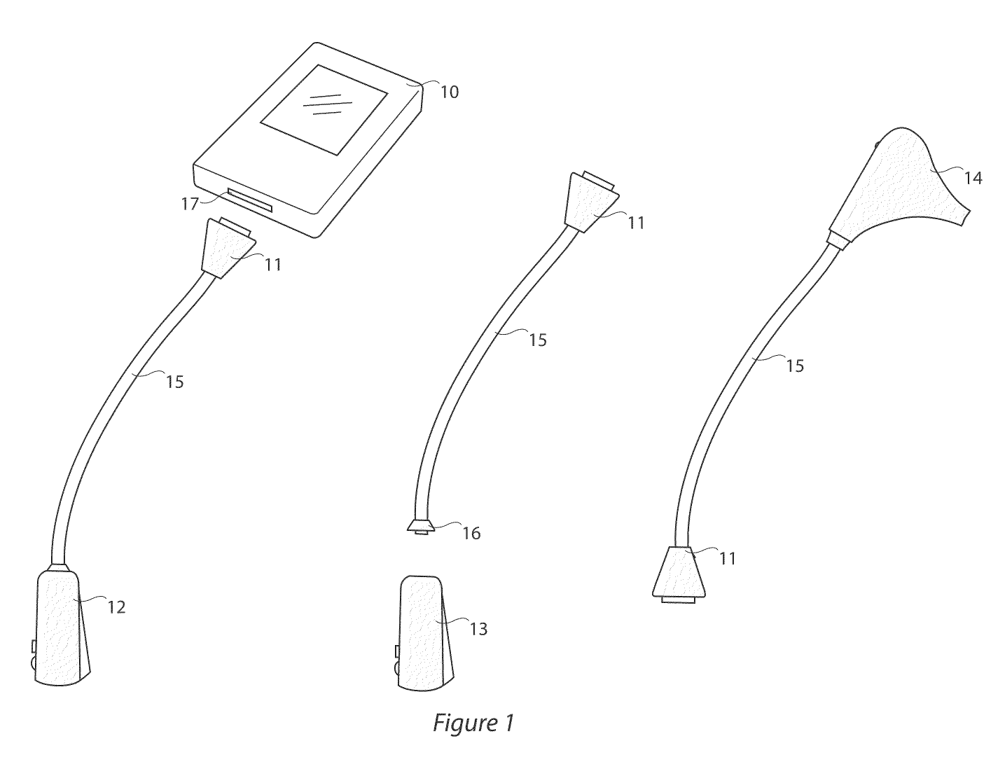

FIG. 1 shows a medical diagnostic device with multiple pluggable diagnostic probe units. There is a DPU 10 and a series of diagnostic probe units: an audio auscultation sensor 12, an ultrasound scanner 13, and an otoscope 14. Each of the diagnostic probe units may be individually connected to the DPU by cable 15 connecting via plug 11 and socket 17.

The cable 15 may be permanently connected to the probe unit as for the auscultation probe 12. Alternatively the cable may have plugs at each end as shown for the ultrasound probe 13.

Upon connection of any one of the probe units, the DPU automatically reconfigures the interface to the probe unit to provide the required communication protocol for communication with the probe unit, and runs software to provide the appropriate display and control features for the functionality of the connected probe unit.

The interface between the DPU and the probe units can support a variety of probe unit with different sensors and functions. The DPU provides a configurable (programmable) interface, where the interface configuration is provided by the probe unit upon connection. The DPU does not need any user intervention to identify the requirements of a probe unit when it is plugged into the DPU. The interface provides a configurable data interface and may also supply power and an optical input interface.

The particular diagnostic probe which is connected to the DPU adapts the medical diagnostic device to any suitable diagnostic function. This function may be, without limitation that of audio devices, ultrasound scanners, otoscopes, ophthalmoscopes, blood testing devices, endoscopes, electro cardiogram devices, skin lesion testing devices, and vital signs testing devices.

Control of the process of collecting medical diagnostic data, for example an ultrasound scan, is provided by a user interface on the hand held device which has as input devices the thumbwheel 18, and the display screen 16 which may be a touchscreen. A virtual keyboard may be provided on the touchscreen. The hand held nature of the device restricts the size of the screen.

The DPU is able to store information concerning the patient or other subject of the data collection or scan. Scans are able to be recorded with associated patient details and details of the device settings used for the scan. This description data may include such generic data as the time of the scan, and parameters relevant to the type of data being collected such as, in the case of an ultrasound scan, the gain settings of the device, the depth setting, and the values of any other parameter settings specific to ultrasound used for the scan.

The user interface allows for annotations entered by the user, which may be voice or text, to be recorded in association with the scan data. Tags and measurement callipers, and the results of measurements of features of the scan, may also be recorded.

The amount of data which can be recorded is limited by the available storage capacity, which will be restricted in a hand held device. The annotations which a user may enter may also be limited by the difficulty of use of an interface provided on a hand held device, which will be limited in functionality due to size limitations.

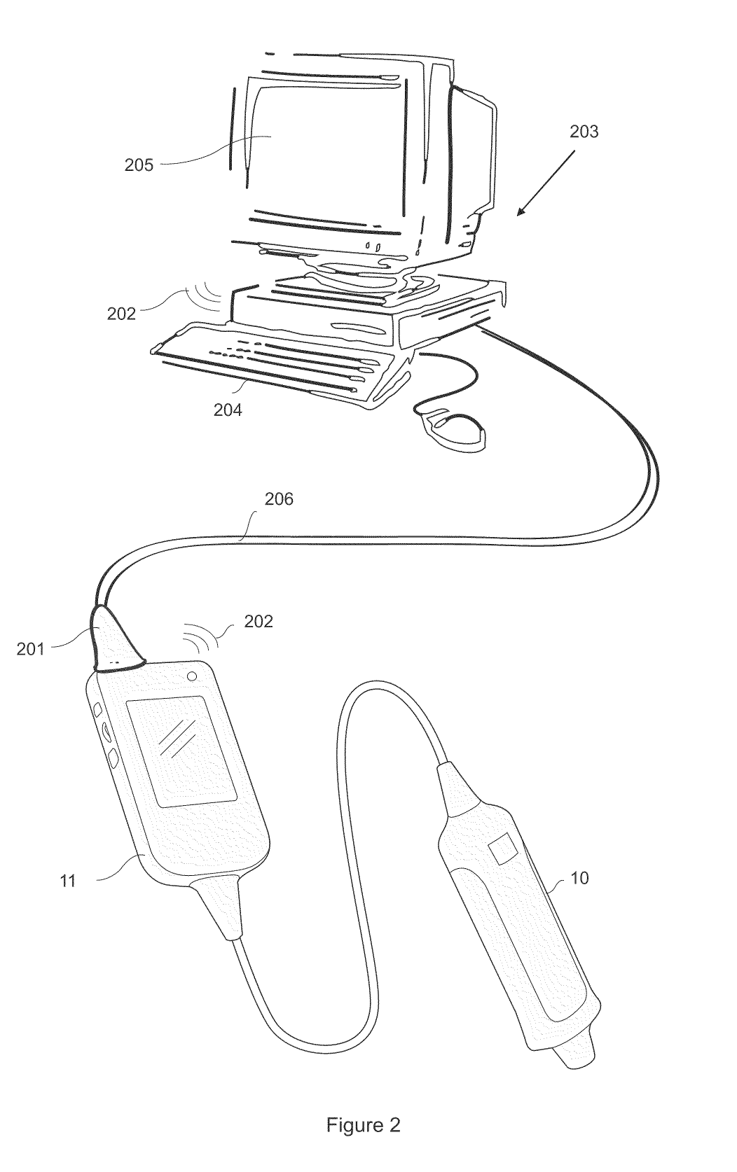

As illustrated in FIG. 2, the hand held device includes a communications connector, in this embodiment a USB connector 201. A wireless connection 202 may be provided in addition to or instead of this USB connection.

These connections connect to a computer 203. This computer includes a keyboard 204 and a computer display 205.

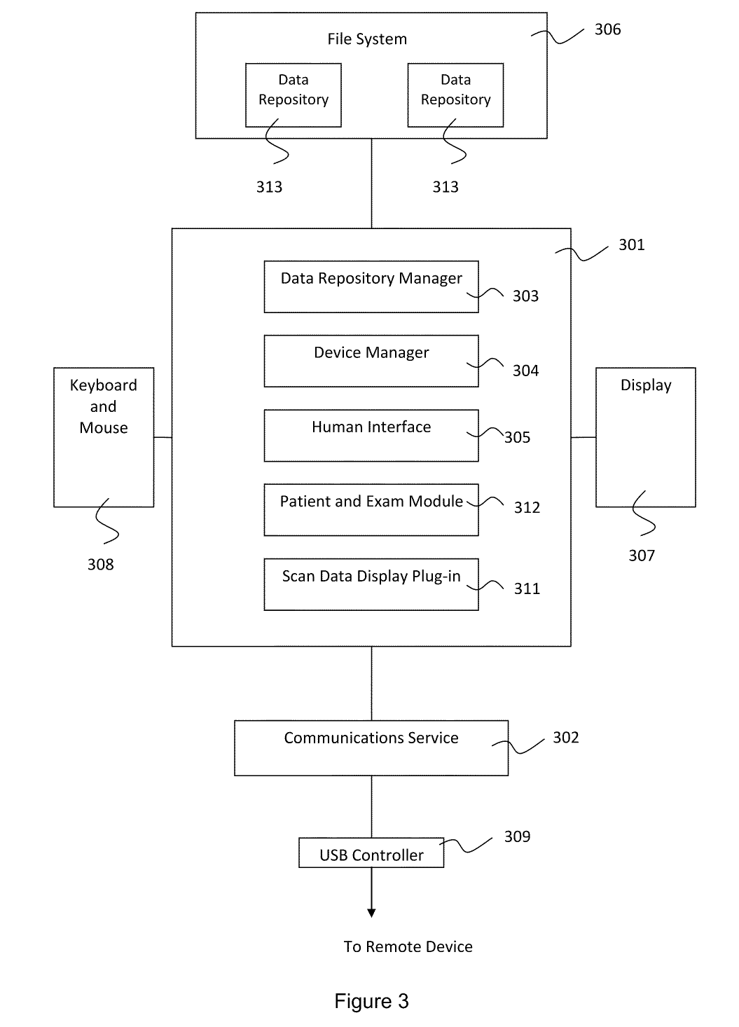

As illustrated in block diagram form in FIG. 3, the computer 203 runs a Data and Device control program. This program includes Main module 301 and Communications Service 302.

The Communications Service 302 runs at least at all times when the program is active. The Communications Service 302 registers itself with the operating system of the computer.

In use, a user connects the DPU 11 of the hand held device to the computer 203 via a USB connector 206.

The computer's USB Protocol Controller 309, detects this connection and receives identifying data about the connected device from the connected device.

One possible connection type between the computer and the device is via USB Mass Storage. Mass Storage is natively supported my most operation systems, and removes the need to write custom drivers. Mass Storage allows the computer to directly access the files on the device which allows synchronisation to occur using standard file system access. Additional communication commands that require responses or actions performed by the device can be implemented as vendor specific SCSI commands over mass storage, which are supported by the operating system API.

The connection is notified to the operating system and thus the Communications Service is notified of the presence of a USB device.

The Communications Service opens a system device node associated with the newly connected device. This node includes the identification data provided by the connected device. This identity is checked, and if it corresponds to a device of a type which the Data and Device Control program is adapted for use with, the Communications Service will start an instance of the Main Processing Module.

In the event that an instance of the Main Processing Module is already running, the newly started instance will activate the existing instance and terminate itself.

The Main Processing Module 301 includes a Human Interface Module 305, which allows it to communicate with a user via the computer display 307 and the computer's keyboard and mouse 308.

The Main Processing Module 301 also includes Device Manager 304. The Device Manager communicates with the attached DPU 10 upon connection.

The Device Manager sends commands to the software running on the DPU. The time setting of the DPU is updated to agree with the time setting of the computer.

Version Information detailing the version of the software running on the DPU is accessed by the Device Manager. This may be stored in any convenient manner, for example a version data file.

The Data and Device Control program includes corresponding version information for the latest software updates available to it for the DPU. These updates are made available to the Data and Device Control program by connection, via the computer to a further remote computer system on which data updates are made available be the manufacturer of the hand held device. This connection may be via the internet.

A comparison is made between the version information obtained from the hand held device and that held by the Data and Device Control program. If this indicates that a software upgrade is available, the user is offered, via the computer screen, an opportunity to perform the upgrade.

If the user indicates that the upgrade should take place, the required software is copied to the DPU, and the system is rebooted. Connection to the DPU is then made as before.

The Data and Device Control program is able to store data in the computer's file system 306, via Data Repository Manager 303.

The Data Repository Manager allows for the definition of one or more sets of data called repositories 313, stored in the file system 306, each separately identifiable to the Data and Device Control program. Different data repositories 313 may be defined for different hand held devices, or, where a hand held device has multiple functions, for different functions of one device. For example, a hand held device capable of supporting a probe attachment for performing ultrasound scanning as well as a probe attachment for auscultation may have separate repositories for data relating to the function of each probe. Alternatively, a single repository may be used to hold data from multiple devices, or for all functions of a single device.

Patient data and data resulting from scans which is stored on the hand held device may be transferred to a respective data repository 313.

Patient data may include basic identification information such as name, gender and age, and may also include system identifiers for the patient, and basic medical data.

Each use of the hand held device on a specific patient on a single occasion may result in multiple scan data sets. These data sets are referred to as Exams, but might be called examinations, uses or incidents, depending on the context of use.

Where data has previously been transferred from a hand held device, this data may be synchronised with the data in the repository. The data in the hand held device or the repository may be considered to be the master copy, or the data may be merged, either automatically or under user control.

In order to display the scan data, the Patient and Exam Module 312 displays to the user the available patient names and exam identifiers from the data set. The user selects a patient and exam using the keyboard/mouse 308. An appropriate Scan Display Plug-in 311 is then called to display the contents of that exam. Which plug-in is called is dependent on the nature of the scan data within the exam.

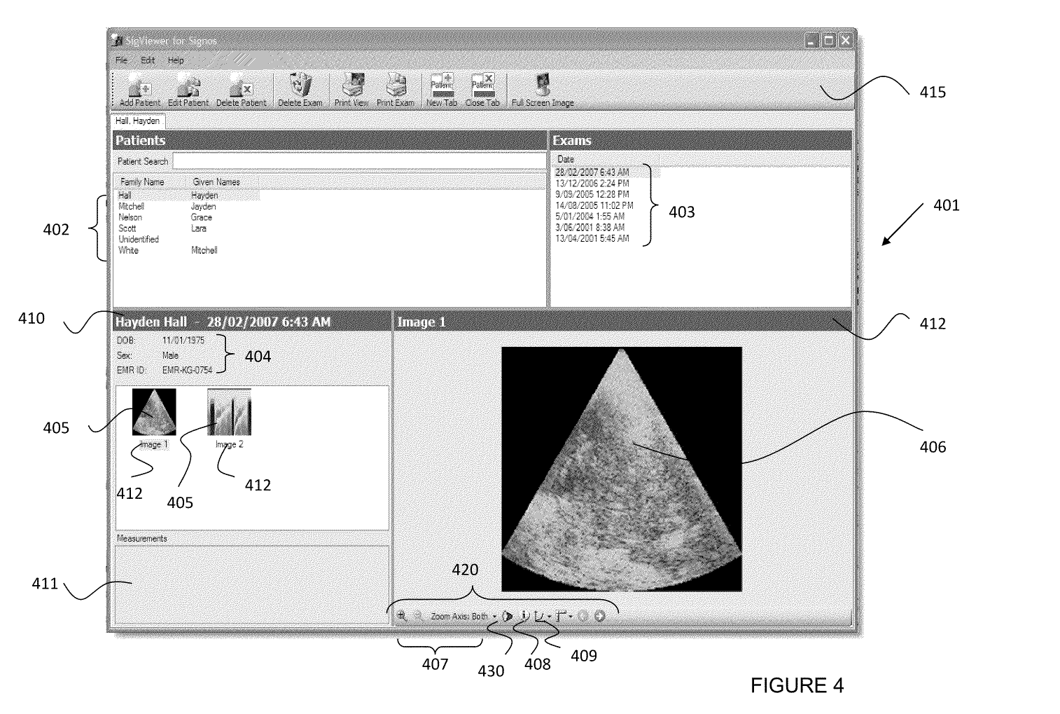

The display screen 401 presented to the user is illustrated in FIG. 4. There is a list of patients for whom scan data is available 402. As these are highlighted, the scan exams available for that patient 403 are displayed. These screen displays are controlled by the Patient and Exam Module 312. Generic controls for all type of data are provided in the toolbar 415. Further toolbars may be provided which are specific to the type of data to be displayed.

When a particular exam 403 is selected, the data stored in the repository for that patient and exam is displayed. The nature of this display is determined by the plug-in 311.

In the illustrated embodiment where the scan data is ultrasound scan data, there is displayed the patient name 410, along with patient details 404.

The scan data consists of ultrasound images. All images taken in a single exam are displayed as thumbnails 405, with individual image identifiers 412.

A user is able to select a thumbnail, and the scan image 406 is then displayed in full size.

The view of the full size image 406 may be changed by controls 420. These include zoom controls 407 which allow the image to be viewed at higher or lower magnifications.

The dynamic range of the displayed image may be changed with control 409. This allows the range of display brightness available to be deployed over a varying range of contrast levels in the image, allowing particular contrasts to be highlighted or concealed.

Image information, being technical data about the scan settings employed when the image was made may be displayed using control 408.

Further controls may be provided, allowing for annotations to be placed on an image, or for existing annotations to be manipulated.

Annotations which have been associated with the image, either via the hand held device or through the remote management system are displayed in the Measurements text box 411. Annotations may be added or existing ones edited in that text box.

Voice annotations may be associated with an image, and there are provided controls for playing or adding such voice annotations. These are accessed via Voice Annotation Control Icon 430.

This screen also provides options for printing the image, and associated annotations, to a printer connected to or controlled by the computer. It also allows for the exporting of images and associated data to remote computers.

The system is also able to display information about the connected hand held device. This information is obtained from the hand held device on connection to the computer.

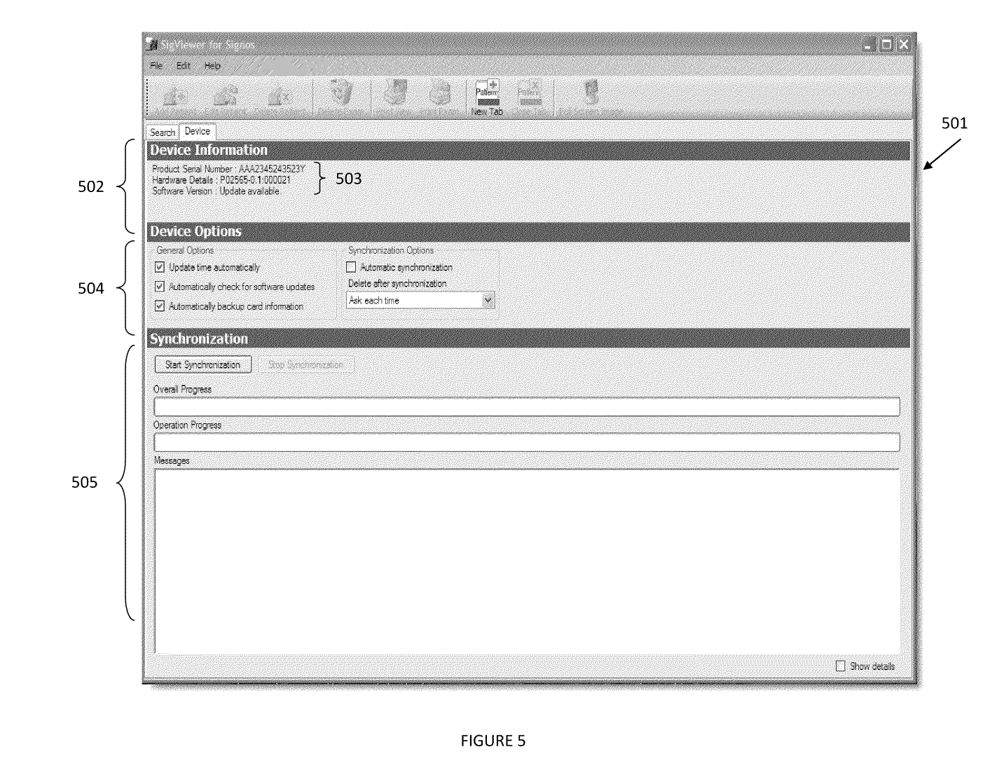

As shown in FIG. 5, there is a device screen 501. This includes a Device Information section 502, which identifies the particular device. In the illustrated embodiment, this includes a serial number, the revision status of the attached device hardware and software 503. The revision numbers associated with any probe connected to the hand held device may also be displayed.

Options specific to the attached device are shown in Device Options section 504. These may include any parameters of the device which are user settable. In the illustrated embodiment, these include settings for automatic update of the time on the hand held device, for automatic synchronisation of data between the data repository and the storage on the device, an automatic check for software upgrades and settings for synchronisation between the data in the repository and the data on the attached device.

There is provided a Synchronisation section 505 which controls and displays the status of synchronisation of data between the hand held device and data held on the computer.

This ability to synchronise data allows for the entry of patient details data to be made using the remote management system with its large screen and full size keyboard, more conveniently than by using the necessarily restricted input means provided by the hand held device. When the hand held device is reconnected, the new or amended patient data can be transferred to the database on the hand held device. Scan data, meanwhile can be transferred to the computer for storage, display and analysis.

In the illustrated embodiment, the Communications Service runs as a service on the Windows operating system. This has the advantage that the Data and Device Control program can be executed by an ordinary user. Updating the remotely connected device, setting the time and rebooting the device require elevated user privileges. The service runs independently of the Main Processing Module, and so can be started with elevated privileges.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A system for remote management of a hand held medical device including connectable hardware providing a communications channel between the device and a remote computer system;
the remote computer including a computer readable media including program instructions which when executed by a processor cause the processor to identify at least the class of the device to the system and to provide access to a data store of the device;
the instructions further causing the system to transfer medical scan data from the data store of the device to a memory storage of the system;
the instructions further causing the system to manipulate the scan data to store, examine and annotate the scan data and to display the scan data and any associated patient information or annotations to a user of the system.

2. The system of claim 1 wherein the instructions further cause the processor to update operational parameter data or operational software of the hand held device.

3. The system of claim 1 wherein patient identification data is transferred to the hand held device.

4. The system of claim 3 wherein the patient identification data is sourced by the system from a further external computer system, being a hospital records system.

5. The system of claim 1 wherein the program instructions include at least one software plug-in, with different plug-ins being able to be selected for use by the system, the selection being made based on the type of medical scan data transferred from the hand held device.

6. The system of claim 1 wherein the system includes a screen of greater size and/or resolution than a screen provided on the hand held device.

7. The system of claim 1 wherein the system includes a keyboard.

8. A method of remote management of a hand held medical device including providing a communications channel between the device and a remote computer system;
identifying at least the class of the device to the system;
providing access to a data store of the device;
transferring medical scan data from the data store of the device to the system;
manipulating the data to store, examine and annotate the scan data;
displaying the scan data and any associated patient information or annotations to a user of the system.

9. (canceled)

10. (canceled)
